(19) United States
(12) Patent Application Publication
(10) Pub. No.: US 2010/0103263 A1
(43) Pub. Date: Apr. 29, 2010

(54) MOTOR VEHICLE WITH A DISTANCE SENSOR AND AN IMAGING SYSTEM

(75) Inventors: Torsten KANNING, Eltville-Erbach (DE); Justus ILLIUM, Mainz (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/547,208

(22) Filed: Aug. 25, 2009

(30) Foreign Application Priority Data
Aug. 25, 2008 (DE) 102008039606.0

(51) Int. Cl. H04N 7/18; B60Q 1/00

(52) U.S. Cl. 348/148; 340/435; 348/E07.085

(57) ABSTRACT

A motor vehicle encompasses a distance sensor, an imaging system as well as a driving assistance system and/or a display device. To improve the quality of information acquired by the imaging system, the imaging system can be targeted abased on the signals from the radar distance sensor.

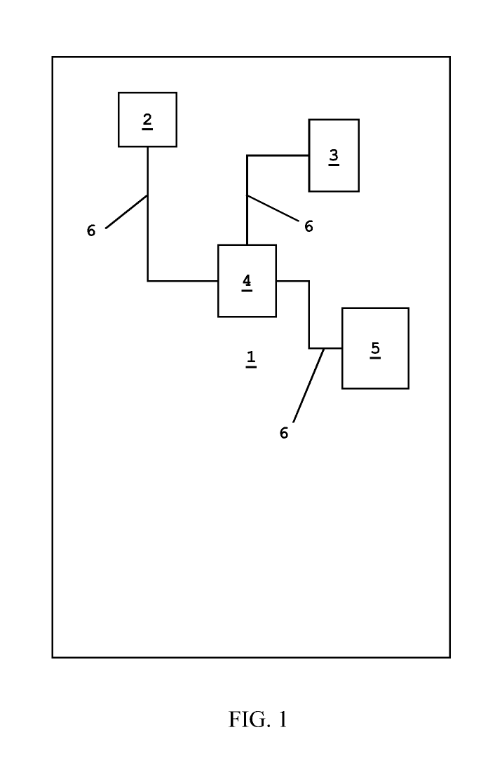

### CROSS-REFERENCE TO RELATED APPLICATION

This application claims priority to German Patent Application No. 102008039606.0, filed Aug. 25, 2008, which is incorporated herein by reference in its entirety.

### TECHNICAL FIELD

The invention relates to a motor vehicle with a distance sensor, an imaging system and a driving assistance system and/or a display device.

### BACKGROUND

Modern motor vehicles are equipped with different systems for assisting a driver, so as to increase active and passive traffic safety. For example, a motor vehicle is equipped with a radar distance sensor, which can automatically monitor the distance from another vehicle in front while driving in traffic. If the safe distance drops below a speed-dependent level, an optical and/or acoustic warning signal can be output. In addition, motor vehicles are often equipped with a driving assistance system comprising an imaging unit, for example in the form of an LCD camera, as well as an accompanying image processor. For example, such driving assistance systems can be used to acquire traffic signs, junctions, intersections, parking spaces and the like and displayed to the driver.

DE 10 2005 004 511 A1 describes a method for warning about a lane departure while a motor vehicle is in the process of passing, wherein a lane marking can be optically detected. The type of lane marking, for example a yellow marking in a construction zone, and data from a navigation system can here be taken into account. Among other devices, radar sensors can also be used for imaging purposes. In addition, guardrails and objects on the side of the roadway can be monitored and displayed to a driver. In addition, DE 10 2004 037 870 A1 shows an optical module of an assistance program in a motor vehicle, which makes it possible to detect traffic signs, locate obstacles and avoid potential accidents. Further, DE 199 34 670 A1 discloses an object detection system for a motor vehicle with at least three object detectors, each having different sensing ranges. This respectively enables optimal object detection, for example an obstacle at various distances. DE 102 55 797 A1 describes a method for acquiring the surroundings of a motor vehicle, which can monitor a lane along with objects lying on the side of the road, such as traffic signs. An imaging system here evaluates detected objects. Finally, DE 10 2004 015 040 A1 relates to a camera in a motor vehicle that can monitor both a lane and the functionality of a rain sensor.

Known motor vehicles have numerous driving assistance systems in order to monitor lane compliance, correct safe distance and speed adjusted to weather conditions, as well as to issue corresponding warning messages. However, these driving assistance systems operate largely independently from each other, as a result of which the image quality of an imaging system deteriorates with the onset of precipitation, for example.

At least one object of the invention is to provide a motor vehicle of the kind mentioned at the outset that improves the operation of various driving assistance systems. In addition, other objects, desirable features and characteristics will become apparent from the subsequent summary and detailed description, and the appended claims, taken in conjunction with the accompanying drawings and this background.

### SUMMARY

The at least one object is achieved according to the invention in that the imaging system can be adjusted based on signals from the distance sensor. The distance sensor is preferably a radar or laser distance sensor.

For example, motor vehicles designed in this way have a known radar distance sensor, which can monitor the distance from another road user driving immediately ahead by transmitting and receiving reflected electromagnetic waves. If a speed-dependent safe distance is not kept, an optical and/or acoustic warning signal is emitted, or a braking maneuver is automatically initiated. In addition, the motor vehicle has an imaging system that comprises part of the driving assistance system. The imaging system, for example an LCD camera, can detect and evaluate correct lane compliance, parking spaces and traffic signs positioned on the side of the road, and then output corresponding information to the driver. In addition, the motor vehicle is designed in such a way that radar distance sensors are able to detect deteriorating visibility conditions. The latter can be caused by fog, strong rain or snowfall, for example, wherein the increased atmospheric humidity alters the quality or strength of the received or reflected signals. When the radar distance sensor detects such deteriorated visibility conditions, the signals of the radar distance sensor are additionally monitored for traffic signs, guardrails and the like on the side of the roadway. Such objects are usually made of metal, so that they give off a clear radar echo. If such objects are automatically detected, the imaging system is automatically adjusted to cover these areas, as a result of which only those specific areas that have traffic signs, for example, have to be acquired and evaluated. This makes it possible to reduce the monitoring area, thereby decreasing the amount of data to be processed. Therefore, the imaging system can be geared directly toward the traffic sign detected by the radar distance sensor, for example, so that it can acquire and process the semantic content therein at the greatest possible magnification. Of course, a distance can also be acquired to correspondingly focus the imaging system.

At least one advantage to the invention is that only components or driving assistance systems already present in the motor vehicle need to be correspondingly actuated preferably by a central control device in the motor vehicle, and the respectively present signals must be processed. As a result, only minimal hardware and/or software adjustment are required, necessitating virtually no additional outlay during the manufacture of the motor vehicle. This makes it possible to provide a driver with additional and higher quality information to enhance traffic safety.

A laser distance sensor can be used in the same way as a radar distance sensor for detecting traffic signs or guardrails, for example, wherein the received signals or laser reflexes must be evaluated to determine whether they were actually reflected by a traffic sign or a guardrail.

Not only radar or laser distance sensor can be used within the framework of the invention for detecting a traffic sign, for example, so too can all other types of sensors. It is also possible for detection to occur during normal operation under good visibility conditions, so as to correspondingly target the imaging system.

In one embodiment, the driving assistance system can be used to automatically detect traffic signs positioned on the edge of the roadway or above the roadway, and output corresponding messages to the driver. If such a traffic sign is detected by the radar distance sensor, in particular under conditions of deteriorated visibility, the imaging system is automatically honed into this area, so as to directly acquire this traffic sign.

As an alternative, the driving assistance system can be a lane assistance system that monitors correct lane compliance. The distance sensor can detect guardrails, reflector posts and the like on the side of the roadway, so as to deliver corresponding signals to the lane assistance system, thereby focusing optical imaging precisely on those areas in which a traffic sign has already been shown to be present. Intersections, traffic lights or road construction sites can be detected in the same way.

In addition, other sensor signals can be taken into account in targeting the imaging system. For example, if a rain sensor determines the onset of precipitation, the distance sensor is aimed specifically at the lateral areas, so as to scan the edges of the streets for traffic signs or guardrails. The signal of a brightness sensor can be similarly drawn upon to additionally monitor the roadway edges with the distance sensor while driving in darkness. The wiper sensor of a windshield washing system can also be considered, since a high wiper speed denotes strong precipitation, thereby indicating the need for additional monitoring, for example of traffic signs.

In improved visibility conditions, an adaptive driving light can be aimed at this area given the detection of traffic signs. If the distance sensor determines that a traffic sign or road junction is present, an adjustable driving light is automatically swiveled to light up this area. In principle, a separate lighting system can be provided for this purpose.

In addition, the data of a navigation system present in the motor vehicle can also be considered. The stored data about the road and pathway network along with the current vehicle position can be used to infer the presence of an intersection at a short distance, for example, so that the imaging system is directed toward the traffic signs present there, so as to acquire them as precisely and quickly as possible.

Finally, a braking assistance system can also be actuated accordingly once the distance sensor or imaging system has acquired information about a speed limit, for example.

Optical and/or acoustic indications can be output based on the evaluated data so as to provide comprehensive information to the driver. For example, a voice message “speed limit 80 km/h” can be output, or a corresponding text message can be shown on a display in the dashboard of the motor vehicle.

It is understood that the features mentioned above and yet to be described below can be used not just in the combination specified, but also in other combinations. The framework of the invention is only defined by the claims.

### BRIEF DESCRIPTION OF THE DRAWINGS

The present invention will hereinafter be described in conjunction with the following drawing figures, wherein like numerals denote like elements, and.

The only figure in the drawing shows a schematic representation of a motor vehicle according to an embodiment of the invention.

### DETAILED DESCRIPTION

The following detailed description is merely exemplary in nature and is not intended to limit application and uses. Furthermore, there is no intention to be bound by any theory presented in the preceding background and summary or the following detailed description.

The motor vehicle 1 is equipped with a radar distance sensor 2 in order to monitor a speed-dependent safe distance from another road user driving immediately ahead in a manner known in the art. At under a minimum distance, the display device 5 outputs an optical and/or acoustic warning. In addition, the motor vehicle 1 has an imaging system 3, for example in the form of an LCD camera, which can acquire traffic signs or monitor correct lane compliance. All components in the motor vehicle 1 are actuated by a central control device 4, as denoted by the connecting lines 6.

Given a deterioration in visibility conditions, for example due to rain, fog or snow, the elevated atmospheric humidity usually causes a change in the reflections or signals received by the radar distance sensor 2. If such deterioration is detected, these signals can be checked to determine whether traffic signs, reflector posts or guardrails are being detected. Such objects made out of metal usually provide a good radar echo. If a guardrail has been detected, for example, the imaging system 3 or LCD camera can be aimed directly at it so as to precisely inspect this area. This reduces the amount of data to be processed, since only specific, used areas need to be checked for possible informational content, not the entire scanned area. Of course, the camera can be focused on this area or the determined distance for this purpose. For example, after a speed limit traffic sign has been detected, the display device 5 can output a corresponding message.

Naturally, such functionality can be implemented not just under deteriorated visibility conditions, but also during normal driving operation.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle, comprising:
a distance sensor adapted to generate a signal; and
an imaging system adapted to be targeted based on the signal of the distance sensor.

2. The motor vehicle according to claim 1, wherein the distance sensor is a radar sensor.

3. The motor vehicle according to claim 1, wherein the distance sensor is a laser distance sensor.

4. The motor vehicle according to claim 1, wherein the imaging system is adapted to detect a traffic sign.

5. The motor vehicle according to claim 1, wherein the imaging system is a component of a lane assistance system.

6. The motor vehicle according to claim 1, wherein a second signal from a second sensor can be considered when targeting the imaging system

7. The motor vehicle according to claim 6, wherein the second sensor is a brightness sensor.

8. The motor vehicle according to claim 6, wherein the second sensor is a wiper sensor.

9. The motor vehicle according to claim 1, wherein a relevant area can be illuminated with an adaptive driving light.

10. The motor vehicle according to claim 1, wherein data from a navigation system can be considered when targeting the imaging system.

11. The motor vehicle according to claim 1, wherein a braking assistance system can be actuated based on information acquired by the imaging system. device.

12. The motor vehicle according to claim 1, further comprising a display device.
